(19) United States
(12) Patent Application Publication
(10) Pub. No.: US 2012/0290753 A1
(43) Pub. Date: Nov. 15, 2012

(54) CONNECTION METHOD FOR BUS CONTROLLERS AND COMMUNICATION SYSTEM

(75) Inventors: Yoshinori Takai, Kariya-shi (JP); Tomohisa Kishigami, Obu-shi (JP)

(73) Assignee: DENSO CORPORATION, Kariya-city (JP)

(21) Appl. No.: 13/466,369

(22) Filed: May 8, 2012

(30) Foreign Application Priority Data
May 9, 2011 (JP) 2011-104513

(51) Int. Cl. G06F 13/00

(52) U.S. Cl. 710/119

(57) ABSTRACT

A connection method for bus controllers is provided which includes using a logic circuit in which if both signal levels of two input terminals are recessive, a signal level of an output terminal becomes recessive, and if at least one of the signal levels of the two input terminals is dominant, a signal level of the output terminal becomes dominant, defining one of the two bus controllers, which are subject to one-on-one connection, as a first controller, defining the other of the two bus controllers as a second controller, connecting a transmitting terminal of the first controller to one of the two input terminals of the logic circuit, connecting a transmitting terminal of the second controller to the other of the two input terminals of the logic circuit, and connecting receiving terminals of the first and second controllers to the output terminal of the logic circuit.

### CROSS-REFERENCE TO RELATED APPLICATION

This application is based on and claims the benefit of priority from earlier Japanese Patent Application No. 2011-104513 filed May 9, 2011, the description of which is incorporated herein by reference.

### BACKGROUND

1. Technical Field

The present invention relates to a connection method for bus controllers which are configured to transmit or receive a signal via a bus communication path, and a communication system to which the connection method is applied.

2. Related Art

Conventionally, as a communication system using a bus communication path, a CAN (Controller Area Network) compliant communication system is known (e.g. refer to JP-A-2008-131514).

FIG. 2 is a block diagram exemplifying a configuration of a communication system 100 to which CAN is applied.

As shown by solid lines and an alternate long and short dash line in FIG. 2, ECUs (Electronic Control Units) 2, 3, 4, which serve as terminal units, are connected to each other via a first bus 6. The first bus 6 is formed with a two-wire communication path which transmits differential signals. Termination circuits 61 and 62, which suppress reflection of signals, are provided at the ends of the bus.

The ECU 2 (as well as the ECUs 3, 4) includes a microcomputer (CAN built-in microcomputer) 21 and a transceiver 23. The microcomputer 21 includes bus controllers (CAN controllers) 211, 212 which realize the CAN protocol. The transceiver 23 converts a unipolar transmission signal TXD, which is provided from the CAN controller 211, to a differential signal and transmits the differential signal to the first bus 6. In addition, the transceiver 23 converts a differential signal, which is received via the first bus 6, to a unipolar reception signal RXD and provides the reception signal RXD to the CAN controller 211.

As described above, according to CAN, the connection between the CAN controllers 211 is normally performed by using the transceiver 23 and the termination circuits 61, 62.

In addition, according to CAN, dominant (superior) and recessive (inferior) are defined as signal levels of transmission signals. If even one node outputs a dominant signal, the signal level on the communication path becomes dominant. By using such a binary signal, bus arbitration is performed.

Meanwhile, the CAN built-in microcomputer 21 may include a plurality of CAN controllers 211, 212. In this case, an auxiliary CAN controller 212 may exist, which is not used.

By using such an auxiliary CAN controller 212, as shown by dashed lines in FIG. 2, another ECU 9 can be considered to be additionally connected to the ECU 2.

In this case, a CAN controller 912 (CAN built-in microcomputer 91) of the additional ECU 9 and the auxiliary CAN controller 212 of the existing ECU 2 are connected to each other on a one-on-one basis. However, as in the case of the existing CAN network (the first bus 6), the CAN controller 912 and the auxiliary CAN controller 212 are required to be connected to each other via a second bus 8, which is formed of a two-wire communication path, by using transceivers 25, 95 and termination circuits 81, 82, thereby requiring a great number of elements while requiring to ensure the area for mounting the elements.

### SUMMARY

An embodiment provides a connection method for bus controllers which realizes one-on-one connection with a simple configuration required for connection, and a communication system to which the connection method is applied.

As an aspect of the embodiment, a connection method for bus controllers is provided, the bus controllers including a transmitting terminal for outputting a transmission signal provided to a transceiver and a receiving terminal for receiving a reception signal provided from the transceiver, and realizing a protocol including bus arbitration using a binary code having a recessive level which is an inferior signal level on a communication path connected via the transceiver and a dominant level which is a superior signal level on the communication path. The method includes using a logic circuit in which if both signal levels of two input terminals are recessive, a signal level of an output terminal becomes recessive, and if at least one of the signal levels of the two input terminals is dominant, a signal level of the output terminal becomes dominant, and defining one of the two bus controllers, which are subject to one-on-one connection, as a first controller, defining the other of the two bus controllers as a second controller, connecting a transmitting terminal of the first controller to one of the two input terminals of the logic circuit, connecting a transmitting terminal of the second controller to the other of the two input terminals of the logic circuit, and connecting receiving terminals of the first and second controllers to the output terminal of the logic circuit.

### BRIEF DESCRIPTION OF THE DRAWINGS

In the accompanying drawings:

FIG. 1 is a block diagram showing a configuration of a communication system of an embodiment; and

FIG. 2 is a block diagram showing a configuration of a conventional communication system.

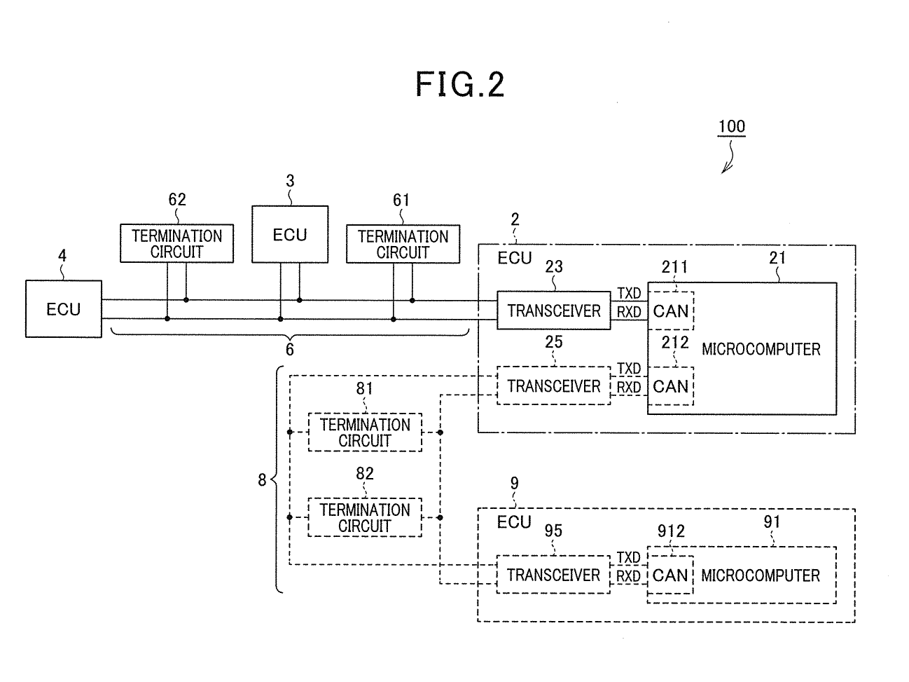

### DETAILED DESCRIPTION OF THE PREFERRED EMBODIMENTS

With reference to the accompanying drawings, hereinafter are described embodiments of the present invention.

(General Configuration)

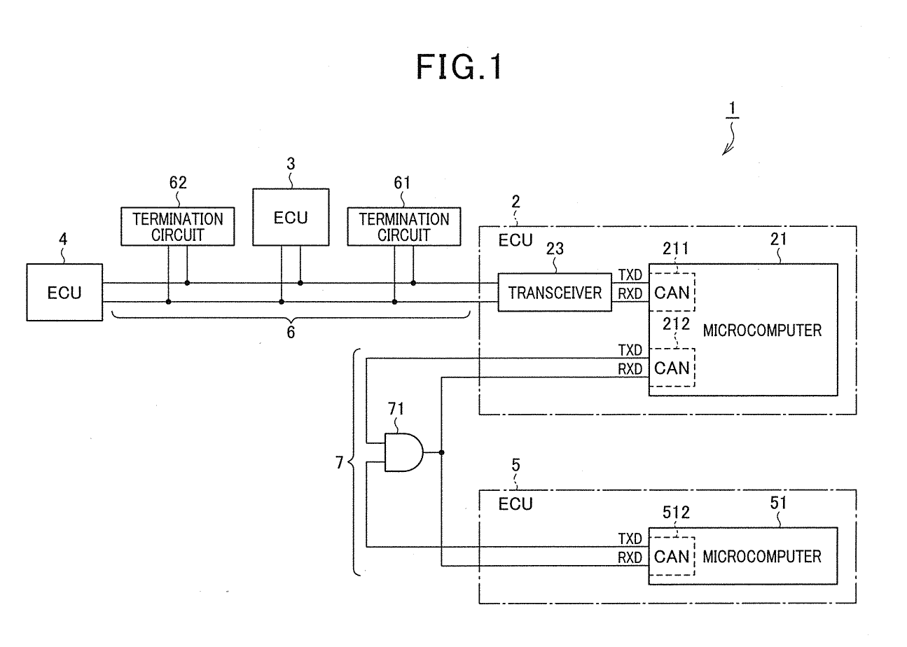

FIG. 1 is a block diagram showing a configuration of a communication system 1 of the embodiment.

The communication system 1 is installed in a vehicle. As shown in FIG. 1, the communication system 1 includes a plurality of electronic control units (ECU) 2 to 5 which serve as terminal units, a first bus 6 which connects the plurality of ECUs 2 to 4 with each other, and a second bus 7 which connects the two ECUs 2 and 5 with each other.

Note that a bus is one communication path which is shared between a plurality of devices to transmit and receive signals. In the embodiment, a communication path through which two devices communicate with each other on a one-on-one basis is also referred to as a bus.

(Configuration of ECU)

The ECU 2 includes a microcomputer (CAN built-in microcomputer) 21 and a transceiver 23. The microcomputer 21 includes two bus controllers (CAN controllers) 211, 212 which realize the CAN protocol. The transceiver 23 converts a unipolar transmission signal TXD, which is provided from a transmitting terminal of the CAN controller 211, to a differential signal and transmits the differential signal to the first bus 6. In addition, the transceiver 23 converts a differential signal, which is received via the first bus 6, to a unipolar reception signal RXD and provides the reception signal RXD to a receiving terminal of the CAN controller 211. Note that the transmitting terminal and the receiving terminal of the CAN controller 212 are directly connected to the second bus 7. The CAN controller 212 directly transmits the transmission signal TXD to the second bus 7 and directly receives the reception signal RXD from the second bus 7 not via a transceiver.

Note that the ECUs 3, 4 connected to the first bus 6 are configured as in the case of the ECU 2 except that the CAN controller 212 is an auxiliary unit and is not used. The CAN controllers 212 of the ECUs 3, 4 may be omitted.

In addition, the ECU 5 connected to the second bus 7 is configured as in the case of the ECU 2 except that the CAN controller 211 and the transceiver 23 are omitted. That is, the ECU 5 is configured with a CAN built-in microcomputer 51 including a CAN controller 512. The transmitting terminal and the receiving terminal of the CAN controller 512 are directly connected to the second bus 7.

(Configuration of Buses)

The first bus 6 is formed with a two-wire communication path which transmits differential signals. Termination circuits 61 and 62, which suppress reflection of a signal, are provided at the ends of the bus.

That is, the CAN controllers 211 are connected to each other via the first bus 6 by using the transceiver 23 and the termination circuits 61, 62.

Signal levels of the signals TXD, RXD transmitted and received by the CAN controllers 211, 212 are referred to as dominant (superior) and recessive (inferior). If even one of the ECUs 2, 3, 4 has outputted a dominant signal, the signal level on the first bus 6 becomes dominant. Using this property, the CAN controller 211 performs bus arbitration. In the present embodiment, dominant is assumed to be low level (0), and recessive is assumed to be high level (1).

Meanwhile, the second bus 7 is configured by using an AND circuit 71 having two inputs. The transmitting terminal of the CAN controller 212 of the ECU 2 is connected to one of the input terminals of the AND circuit 71. The transmitting terminal of the CAN controller 512 of the ECU 5 is connected to the other of the input terminals of the AND circuit 71. The output terminal of the AND circuit 71 is connected to the receiving terminal of the CAN controller 212 of the ECU 2 and the receiving terminal of the CAN controller 512 of the ECU 5.

That is, the second bus 7 connects between the CAN controllers 212 and 512 by using the AND circuit 71.

If even one of the ECUs 2, 5 has transmitted a dominant signal via the second bus 7, the ECUs 2, 5 receive the dominant signal. Using this property, the CAN controllers 212, 512 can perform bus arbitration.

(Advantages)

As described above, the second bus 7 realizes the connection between the CAN controllers 212 and 512 not by using the transceiver 23 and the termination circuits 61, 62 but with a simple configuration in a state where a bus arbitration function using a binary code consisting of recessive and dominant is maintained. Hence, when the auxiliary CAN controller 212, which is not used for the communication with the existing ECUs 3, 4, has been prepared, another ECU 5 can be added by using the auxiliary CAN controller 212 and with low cost.

In the above embodiment, the AND circuit 71 corresponds to a logic circuit, the ECUs 2, 5 correspond to first and second terminal units. The CAN controller 212 of the ECU 2 and the CAN controller 512 of the ECU 5 correspond to first and second controllers.

It will be appreciated that the present invention is not limited to the configurations described above, but any and all modifications, variations or equivalents, which may occur to those who are skilled in the art, should be considered to fall within the scope of the present invention.

(Other embodiments)

Although the second bus 7 is configured with the AND circuit 71, the second bus 7 may be configured with a wired OR circuit instead of the AND circuit 71.

Hereinafter, aspects of the above-described embodiments will be summarized.

As an aspect of the embodiment, a connection method for bus controllers targets at the bus controllers including a transmitting terminal for outputting a transmission signal provided to a transceiver and a receiving terminal for receiving a reception signal provided from the transceiver, and realizing a protocol including bus arbitration using a binary code having a recessive level which is an inferior signal level on a communication path connected via the transceiver and a dominant level which is a superior signal level on the communication path.

In the embodiment, a logic circuit is used in which if both signal levels of two input terminals are recessive, a signal level of an output terminal becomes recessive, and if at least one of the signal levels of the two input terminals is dominant, a signal level of the output terminal becomes dominant.

In addition, one of the two bus controllers, which are subject to one-on-one connection, is defined as a first controller, the other of the two bus controllers is defined as a second controller, a transmitting terminal of the first controller is connected to one of the two input terminals of the logic circuit, a transmitting terminal of the second controller is connected to the other of the two input terminals of the logic circuit, and receiving terminals of the first and second controllers are connected to the output terminal of the logic circuit.

Hence, if different signal levels are simultaneously outputted from the transmitting terminals of the first and second controllers, a dominant signal is inputted to the receiving terminals of the first and second controllers. That is, the bus controllers are connected to each other in a state where a bus arbitration function using a binary code consisting of recessive and dominant is maintained.

As described above, according to the connection method for bus controllers, the connection between the bus controllers can be realized not by using a transceiver and termination circuits but with a simple configuration. Consequently, another terminal unit using an auxiliary bus controller prepared in a terminal can be realized with low cost.

The communication system includes a first terminal unit and a second terminal unit each of which includes a bus controller including a transmitting terminal for outputting a transmission signal provided to a transceiver and a receiving terminal for receiving a reception signal provided from the transceiver, and realizing a protocol including bus arbitration using a binary code having a recessive level, which is an inferior signal level on a communication path connected via the transceiver, and a dominant level, which is a superior signal level on the communication path.

In addition, a logic circuit is used in which a signal level of the output terminal becomes recessive if both signal levels of the two input terminals are recessive, and a signal level of the output terminal becomes dominant if at least one of the signal levels of the two input terminals is dominant. The first terminal unit and the second terminal unit are connected to each other in a state where a transmitting terminal of a first controller, which is a bus controller of the first terminal unit, is connected to one of the two input terminals, and a transmitting terminal of a second controller, which is a bus controller of the second terminal unit, is connected to the other of the two input terminals, and receiving terminals of the first and second controllers are connected to the output terminal.

Since the communication system configured as described above employs the above described connection method for bus controllers, the communication system can obtain the same advantages as those of the method.

Note that the protocol realized by the bus controllers may be the CAN protocol. In this case, the communication system is suitable for an in-vehicle communication network.

What is claimed is:

1. A connection method for bus controllers, the bus controllers including a transmitting terminal for outputting a transmission signal provided to a transceiver and a receiving terminal for receiving a reception signal provided from the transceiver, and realizing a protocol including bus arbitration using a binary code having a recessive level which is an inferior signal level on a communication path connected via the transceiver and a dominant level which is a superior signal level on the communication path, comprising:
using a logic circuit in which if both signal levels of two input terminals are recessive, a signal level of an output terminal becomes recessive, and if at least one of the signal levels of the two input terminals is dominant, a signal level of the output terminal becomes dominant; and
defining one of the two bus controllers, which are subject to one-on-one connection, as a first controller, defining the other of the two bus controllers as a second controller, connecting a transmitting terminal of the first controller to one of the two input terminals of the logic circuit, connecting a transmitting terminal of the second controller to the other of the two input terminals of the logic circuit, and connecting receiving terminals of the first and second controllers to the output terminal of the logic circuit.

2. A communication system, comprising:
a first terminal unit and a second terminal unit each of which includes a bus controller including a transmitting terminal for outputting a transmission signal provided to a transceiver and a receiving terminal for receiving a reception signal provided from the transceiver, and realizing a protocol including bus arbitration using a binary code having a recessive level, which is an inferior signal level on a communication path connected via the transceiver, and a dominant level, which is a superior signal level on the communication path; and
a logic circuit which has two input terminals and an output terminal, and in which a transmitting terminal of a first controller, which is a bus controller of the first terminal unit, is connected to one of the two input terminals, and a transmitting terminal of a second controller, which is a bus controller of the second terminal unit, is connected to the other of the two input terminals, receiving terminals of the first and second controllers are connected to the output terminal, a signal level of the output terminal becomes recessive if both signal levels of the two input terminals are recessive, and a signal level of the output terminal becomes dominant if at least one of the signal levels of the two input terminals is dominant.

3. The communication system according to claim 2, wherein the protocol is the CAN protocol.
